(19) United States
(12) Patent Application Publication
(10) Pub. No.: US 2012/0112988 A1
(43) Pub. Date: May 10, 2012

(54) DISPLAY DEVICE

(76) Inventors: Norio NAKANISHI, Chiba (JP); Koichi Igeta, Chiba (JP)

(21) Appl. No.: 13/291,125

(22) Filed: Nov. 8, 2011

(30) Foreign Application Priority Data
Nov. 8, 2010 (JP) 2010-249766

(51) Int. Cl. G09G 3/36; G09G 3/30

(52) U.S. Cl. 345/76; 345/87

(57) ABSTRACT

Luminance ununiformity and color shading are prevented in a display area of an irregular hexagonal shape formed by cutting-off a corner from a rectangular shape.

Sub-pixels are formed in each of regions surrounded by scanning lines and video signal lines and a set of sub-pixels by the number of three define one pixel. The display area is an irregular hexagonal shape containing a display area sloping portion of a shape formed by cutting-off a corner from a rectangular shape. In the display area sloping portion, the number of sub-pixels in the extending direction of the scanning lines changes uniformly for every sub-pixels by the number of three or by the number of a multiple thereof on each side of the display area for one scanning line. The magnitude of the video signal in the source driver can be controlled easily by uniformly changing the number of the sub-pixels.

### CLAIM OF PRIORITY

The present application claims priority from Japanese Patent Application JP 2010-249766 filed on Nov. 8, 2010, the content of which is hereby incorporated by reference into this application.

### BACKGROUND OF THE INVENTION

1. Field of the Invention

The present invention relates to a display device and particularly relates to a display device having an outer profile modified from a rectangular shape to an irregular shape so as to conform to a display device of a special shape.

2. Description of the Related Art

A liquid crystal display panel used in a liquid crystal display device includes a TFT substrate, a counter electrode opposing the TFT substrate, and liquid crystals put between the TFT substrate and the counter substrate. The TFT substrate has pixels including pixel electrodes, thin film transistors (TFT), etc. formed thereon in a matrix form. The counter electrode has color filters, etc. formed at positions corresponding to the pixel electrodes of the TFT substrate. The liquid crystal display device forms images by controlling light transmittance of each pixel using liquid crystal molecules.

Since the liquid crystal display devices are flat and light in weight, their application use has been extended in various fields. Recently, they have been utilized also for the display of speed meters, etc. attached to dashboards of automobiles. For use in the automobile dashboard, a liquid crystal display device having a shape where corners are cut-off so as to conform to the shape of the dashboard has been demanded rather than a rectangular shape. In this case, also the display area is cut-off at the corners conforming to the irregular outer shape.

As an example of a liquid crystal display device cut-off at the corners, WO02008/062575 describes a liquid crystal display device which is cut-off at the corners into an irregular hexagonal shape. In the configuration of such an irregular hexagonal shape, as the counter measure for the luminance ununiformity due to the difference of a load connected to video signal lines, particularly, a capacitance load between the scanning line and the video signal line, WO02008/062575 discloses that the video signal lines are intersected with the scanning lines at the outside of the display area thereby unifying the capacitance load to the video signal lines.

As a configuration for coping with change of luminance for every area by the difference of the load due to the irregular shape of the display area, WO02007/105700 also discloses that video signal lines are intersected with scanning lines and providing a dummy pixel at the outside of the display area thereby unifying the capacitance load to the video signal lines. In addition, JP-A-2008-261938 also discloses a liquid crystal display device having an irregular outer shape.

### SUMMARY OF THE INVENTION

To compensate for the luminance ununiformity due to the difference of load of video signal lines in a liquid crystal display device having a display area of a irregular shape formed by cutting-off a corner from a rectangular shape, WO02008/062575 or WO02007/105700 discloses the configuration in which the scanning lines are intersected with the video signal line, or providing a dummy pixel to the outside of the display area. However, such a configuration is required to ensure a space therefor in addition to the display area and involves a problem with increase in the outer shape of the liquid crystal display device by so much at the corner cut-off portion.

The present invention intends to provide a display device of an irregular shape capable of suppressing generation of luminance ununiformity without forming intersections between the scanning lines and the video signal lines for unifying the load of the video signal lines or providing the dummy pixel for unifying the load of the video signal at the outside of the display area. Further, the invention also intends to provide a display area of an irregular shape having the outer size being decreased as much as possible.

Main specific features of the present invention for overcoming the problems are to be described below.

The present invention provides, in a first aspect, a display device comprising: scanning lines extended in a first direction and arranged in a second direction; video signal lines extended in the second direction and arranged in the first direction; and sub-pixels formed in each of regions surrounded by the scanning lines and the video signal lines, a set of the sub-pixels by the number of n defining a pixel (e.g. a set of three pieces); wherein the display area has an irregular hexagonal shape containing a display area sloping portion of a shape formed by cutting-off a corner from a rectangular shape, and the number of the sub-pixels in the extending direction of the scanning lines in the display area sloping portion changes uniformly for every sub-pixels by the number of n or for every sub-pixels by the number of a multiple of n on each side of the display area for every one scanning line.

The present invention provides, in a second aspect, a display device comprising: scanning lines extended in a first direction and arranged in a second direction; video signal lines extended in the second direction and arranged in the first direction; and sub-pixels formed in each of regions surrounded by the scanning lines and the video signal lines, a set of the sub-pixels by the number of n defining a pixel (e.g. a set of three pieces); wherein the display area has an irregular hexagonal shape containing a display area sloping portion of a shape formed by cutting-off a corner from a rectangular shape, the angle of the display area sloping portion relative to the scanning line is represented by tan⁻¹(yp/xp) assuming the horizontal diameter of a pixel as px and the vertical diameter of the pixel as py, and the number of the sub-pixels in the extending direction of the scanning lines in the display area sloping portion changes uniformly for every sub-pixels by the number of n or for every sub-pixels by the number of a multiple of n on each side of the display area for every one scanning line.

The present invention is applicable to a liquid crystal display device or an organic EL display device in which pixels or sub-pixels are arranged in a matrix.

According to the invention, in a display device in which the display area has an irregular hexagonal shape containing a display area sloping portion of a shape formed by cutting-off a corner from a rectangular shape, the size of the video signal line in the source driver can be controlled easily for preventing luminance ununiformity on the screen being from generated. Accordingly, occurrence of luminance ununiformity or color shading can be prevented in a display device having a display area of an irregular hexagonal shape.

### BRIEF DESCRIPTION OF THE DRAWINGS

FIG. 1 is a plan view of a liquid crystal display device of the present invention;

FIG. 2 is a cross-sectional view along line A-A in FIG. 1;

FIG. 3 is an enlarged view near an display area sloping portion of a first embodiment;

FIG. 4 is a plan view of a sub-pixel and a pixel of the first embodiment;

FIG. 5 shows video signal lines near the display area sloping portion of the first embodiment;

FIG. 6 is an enlarged view near the display area sloping portion of a comparative example;

FIG. 7 shows video signal lines near the display area sloping portion of the comparative example;

FIG. 8 is an enlarged view near the display area sloping portion of a second embodiment;

FIG. 9 shows video signal lines near the display area sloping portion of the second embodiment;

FIG. 10 is an enlarged view near the display area sloping portion of a third embodiment;

FIG. 11 is a plan view of a sub-pixel and a pixel of the third embodiment; and

FIG. 12 shows video signal lines near the display area sloping portion of the third embodiment.

### DESCRIPTION OF THE PREFERRED EMBODIMENTS

### First Embodiment

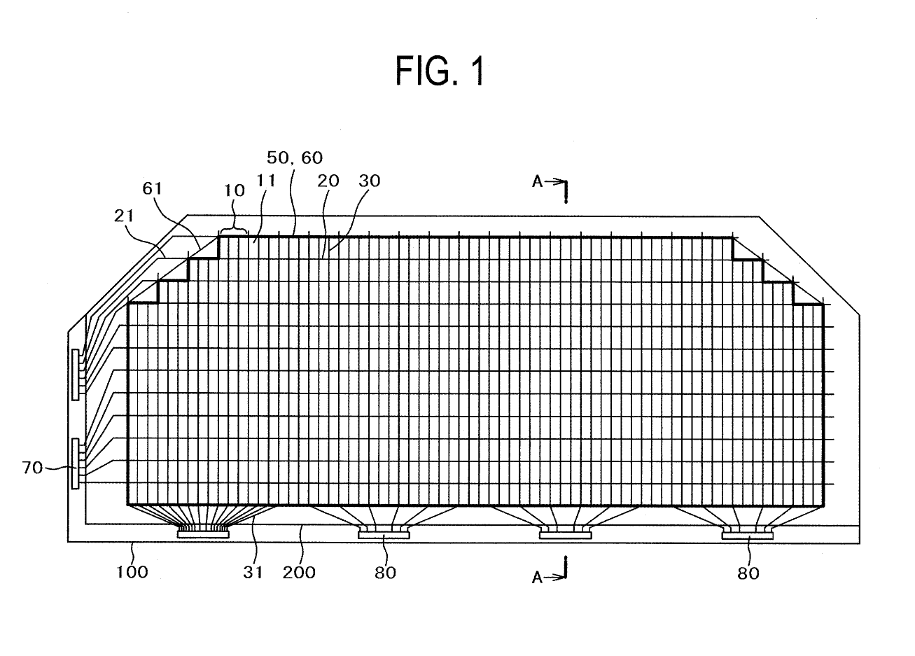

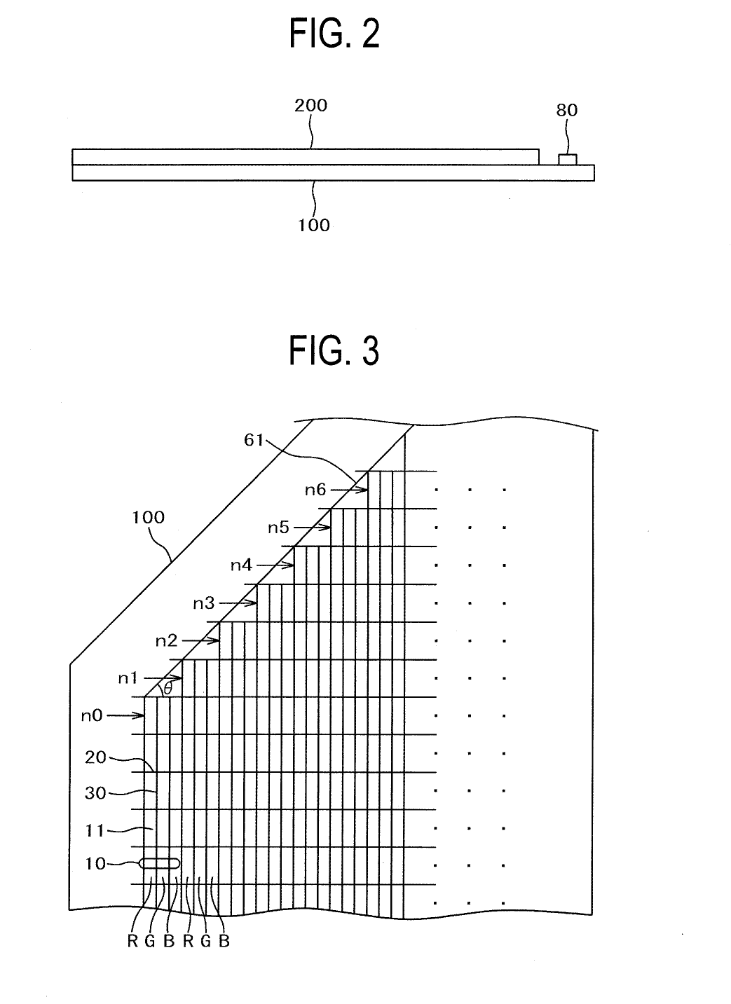

FIG. 1 is a plan view of a liquid crystal display device according to the present invention. The liquid crystal display device in FIG. 1 has a irregular hexagonal shape in which corners of a rectangle are cut-off. FIG. 2 is a cross-sectional view along line A-A in FIG. 1. In FIG. 1 or FIG. 2, a counter substrate 200 having color filters, etc. formed thereon is disposed over a TFT substrate 100 having pixels 10 formed in a matrix. A not illustrated liquid crystal layer is put between the TFT substrate 100 and the counter substrate 200.

In FIG. 1, the TFT substrate 100 is formed larger than the counter substrate 200, and gate drivers 70 for driving scanning lines 20 or source drivers 80 for driving video signal lines 30 are arranged at a portion in which the TRT substrate 100 is made larger than the counter substrate 200.

The scanning lines 20 are extended horizontally and arranged vertically in the display area 60. Further, the video signal lines 30 are extended vertically and arranged horizontally. The scanning lines 20 and the gate drivers 70 are connected by scanning line leads 21, and the video signal lines 30 and the source drivers 80 are connected by video signal line leads 31.

While the source drivers 80 are connected to all of the video signal lines 30, the video signal lines leads 31 for connecting all of the video signal lines 30 are shown only for the leftmost source driver 80 in FIG. 1 for the sake of avoiding complexity of the drawing.

In FIG. 1, a pixel forming area 50 is surrounded by a fat line. The pixel 10 comprises three sub-pixels 11, that is, an R sub-pixel 11 (red sub-pixel 11), a G sub-pixel 11 (green sub-pixel 11), and a B sub-pixel 11 (blue sub-pixel 11). In FIG. 1, while the pixel forming area 50 and the display area 60 are identical, the display area 60 defines an envelope for the pixel forming area 50 at corner cut-off portions. The envelope is referred to as a display area sloping portion 61. The pixel forming area 50 and the display area 60 are used for an identical meaning except for the case they should be distinguished particularly.

In the display area sloping portion 61 in FIG. 1, the number of pixels 10 in the horizontal direction is decreased toward the upper side. In FIG. 1, two pixels, that is, six sub-pixels are decreased in total for right and left sides for every one scanning line, that is, for every one scanning line. In FIG. 1, sub-pixels 11 are formed in each of regions surrounded by the scanning lines 20 and the video signal lines 30.

Further, a pixel electrode and a TFT are formed for every sub-pixel. That is, the display area 60 comprises on the unit of the sub-pixels 11. Accordingly, when the display area 60 is to have a sloping portion, the envelope is formed most smoothly if the sloping portion is formed with the sub-pixel 11 being as the unit. However, the display area 60 is formed at the display area sloping portion 61 with three sub-pixels as a unit in the invention. That is, the envelope in the display area sloping portion 61 is formed on the basis of the pixel or on the basis of three sub-pixels. This is a feature of the invention.

That is, while the pixel 10 comprises R, G, and B sub-pixels 11, if an envelope for the display area sloping portion 61 is formed on the basis of the sub-pixel so as to smooth the sloping portion of the display area 60 as much as possible, the length of the video signal lines 30 is different within the pixel 10 to cause color shading in the pixel 10.

In the invention, priority is given to the prevention of the color shading in the pixel 10 at the display area sloping portion 61 rather than to the smooth formation of the display area sloping portion 61 with a geometrical point of view.

FIG. 3 is an enlarged plan view for the display area sloping portion 61 in FIG. 1. In FIG. 3, video signal lines 30 are extended in the vertical direction for every sub-pixel 11. In the display area sloping portion 61, the number of the sub-pixels 11 in the horizontal direction is decreased toward the upper side. Since the number of the sub-pixels 11 is decreased for every three on each side of the display area, the number decreased for every by six on both sides of the display area.

In FIG. 3, n0, n1, n2, etc. each represent the number of sub-pixels 11 in the horizontal direction on each side of the display area. n0 is a number of the sub-pixels 11 in a full size display area in the horizontal direction on each side of the display area. Accordingly, n0−n1=3, n1−n2=3, n3−n2=3, etc. are satisfied.

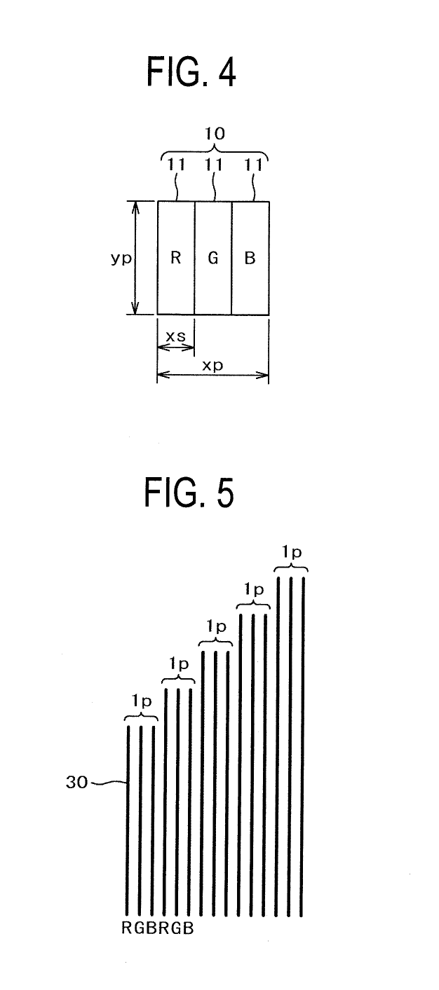

FIG. 4 is a plan view showing a relation between a pixel 10 and sub-pixels 11. In FIG. 4, one pixel comprises three sub-pixels. The size of the sub-pixel 11 is, for example, 50 to 100 μm for the horizontal diameter xs and, for example, 150 to 300 μm for vertical diameter yp and the entire pixel has a square shape where the horizontal diameter xp is equal with the vertical diameter yp.

FIG. 5 is a view in which only the video signal lines 30 are extracted from FIG. 3. In FIG. 5, 1 p shows video signal lines for 1 pixel. As shown in FIG. 5, the length of the video signal lines 30 changes for every three video signal lines. Three video signal lines each correspond to the respective of the three sub-pixels.

In the configuration of FIG. 5, a load of the video signal lines changes for every three video signal lines. Accordingly, even with an identical video signal supplied from the source drier 80, the video signal in each of the sub-pixels 11 is increased in the short portion of the video signal line by so much as the decrease in the load to cause luminance ununiformity.

However, by changing the length of the video signal lines 30 regularly as shown in FIG. 5, and inputting this information to the source driver 80, the magnitude of the video signal can be controlled easily for every video signal line 30. Further, since the length for the video signal line 30 is made identical for every one pixel containing three sub-pixels, even if the magnitude of the video signals is not controlled completely, generation of color shading can be prevented.

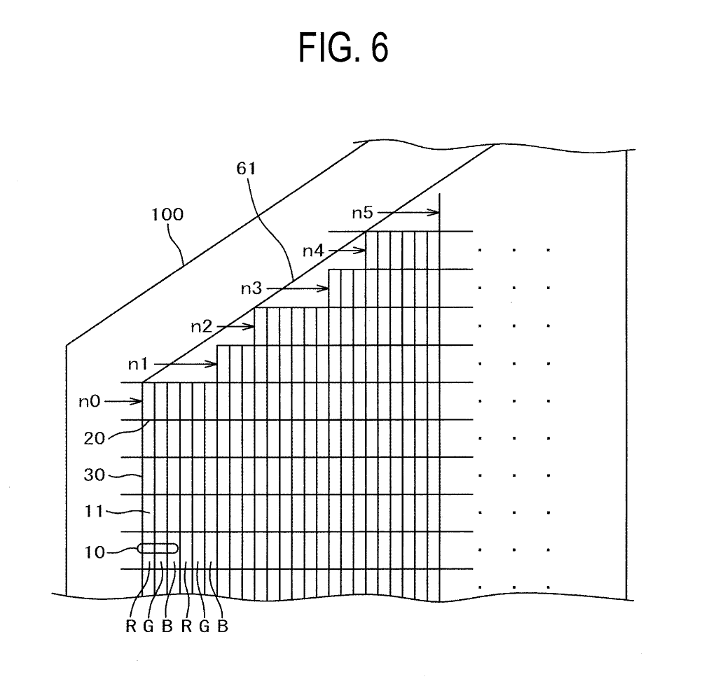

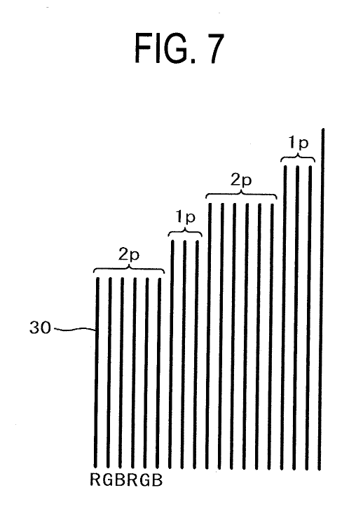

FIG. 6 is an enlarged plan view for a display area sloping portion 61 in FIG. 1 as a comparative example. In FIG. 6, video signal lines 30 are extended in the vertical direction for every sub-pixel 11. In the display area sloping portion 61, the number of the sub-pixels 11 in the horizontal direction is decreased toward the upper side. However, the way of decreasing the number is different from that in the present invention. FIG. 6 includes areas in which the number of the sub-pixels is decreased for every three for every one scanning line on each side, that is, for every six on both sides in total and areas in which the number of the sub-pixels is decreased for every six on each side, that is, for every 12 for both sides in total.

In FIG. 6, n0, n1, n2, etc. each represent the number of sub-pixels 11 in the horizontal direction on each side of the display area. n0 is a number for sub-pixels in a full size display area in the horizontal direction on each side of the display area. Accordingly, n0−n1=6, n1−n2=3, n3−n2=6, etc. are satisfied in FIG. 6, so that the change for the number of the sub-pixel 11 is not uniform.

FIG. 7 is a view in which only the video signal lines 30 in FIG. 6 are extracted. In FIG. 7, the length of the video signal lines 30 changes for every sixth lines or changes for every three lines, which is not a uniform change. When the video signal lines 30 changes not uniformly as described above, formation of video signals in the source driver 80 becomes complicate to increase the manufacturing cost of the source driver 80.

By contrast, since, in the invention, the change of the length of the video signal lines 30 is uniform for every scanning line, the video signals in the source driver 80 can be corrected easily. As described above, according to the invention, also when the shape of the display area is formed to an irregular shape conforming to the outer shape of a liquid crystal display device, color shading or luminance ununiformity can be prevented without enlarging the outer shape of a liquid crystal display device.

### Second Embodiment

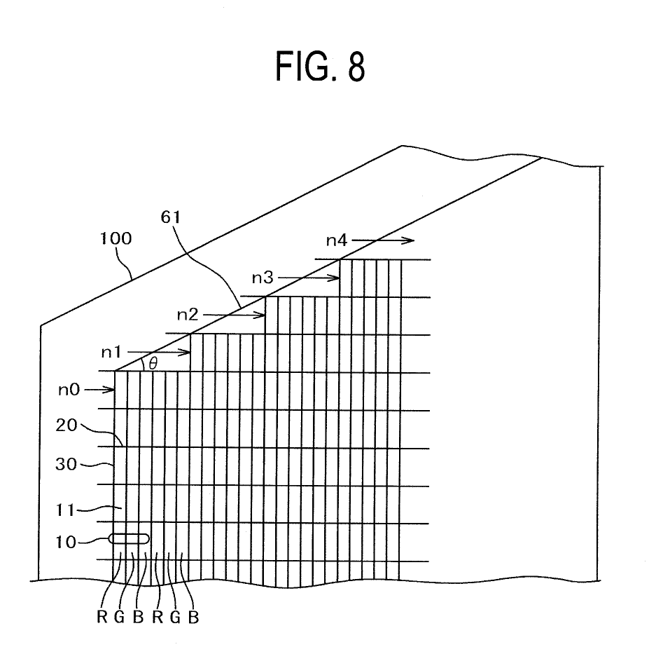

FIG. 8 is a plan view for a corner cut-off portion in a liquid crystal display device showing a second embodiment of the invention. FIG. 8 is an enlarged plan view of a display area sloping portion 61 in FIG. 1. The configuration in FIG. 8 is identical with that in FIG. 3 of the first embodiment except that the number of the sub-pixels is decreased for every six on each side of the display area and for every 12 on both sides in the display area.

That is, in FIG. 8, n0, n1, n2, etc. represent each the number of sub-pixels 11 in the horizontal direction on each side of the display area. n0 is a number of the sub-pixels in a full size display area in the horizontal direction on each side of the display area. Accordingly, n0−n1=6, n1−n2=6, n3−n2=6, etc. are satisfied. The shape of the pixel 10 is identical with that in FIG. 4.

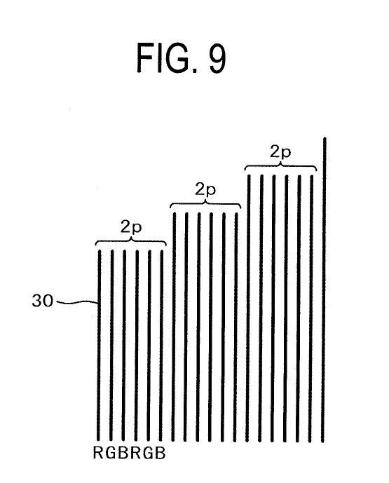

FIG. 9 is a view in which only the video signals 30 in FIG. 8 are extracted. In FIG. 9, 1 p shows video signal lines for 1 pixel. As shown in FIG. 9, the length of the video signal lines 30 changes for every six video signal lines 30. Further, six video signal lines 30 correspond to six sub-pixels. In the configuration of FIG. 9, a load of the video signal lines changes for every six video signal lines. However, by changing the length of the video signal line 30 regularly and inputting this information to the source driver 80, the magnitude of the video signal can be controlled on very video signal line.

Other advantageous effects are identical with those explained in the first embodiment. Further, in this embodiment, while the number of the video signal lines is changed for every six lines on each side of the display area per one scanning line, this is not restrictive but identical effects can be obtained by changing the number also for every 9 or 12.

### Third Embodiment

In the first or second embodiment, the pixel 10 comprises the three sub-pixels 11 and the shape of the pixel 10 is square as shown in FIG. 4. In the case of the first or second embodiment, the angle of inclination θ for the display area sloping portion 61 is defined as tan⁻¹(yp/xp) or 1/2 tan⁻¹(hp/xp), etc. Accordingly, it is difficult to cope with various inclined angles θ in the display area.

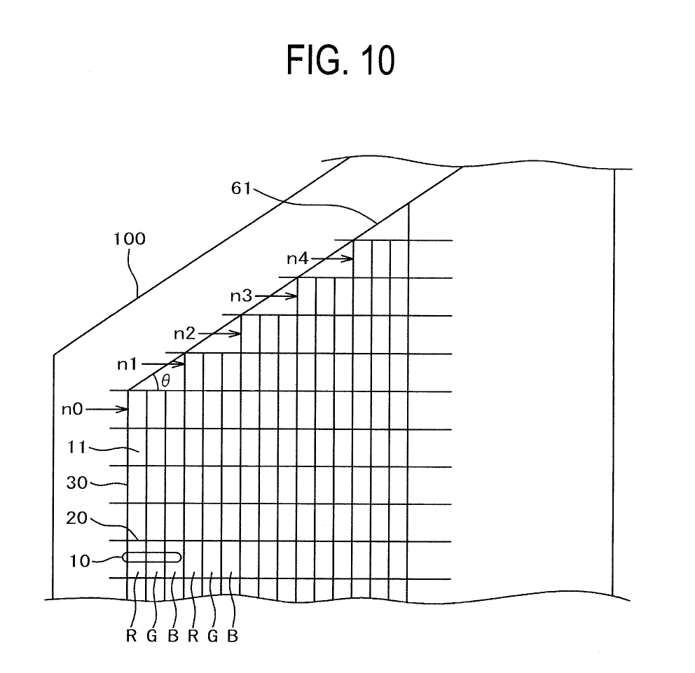

In this embodiment, the invention can cope with optional angle of inclination θ in the display area by changing the shape of the pixel 10 or the shape of the sub-pixel 11 conforming to the angle of inclination θ in the display area. FIG. 10 is a plan view for a corner cut-off portion in a liquid crystal display device showing a third embodiment of the invention. FIG. 10 is an enlarged plan view of the display area sloping portion 61 in FIG. 1.

In FIG. 10, the sub-pixel is decreased for every three on each side of the display area in the same manner as for the first embodiment in FIG. 3. Further, in FIG. 10, assuming that n0, n1, n2, etc. as the number of sub-pixels 11 in the horizontal direction on each side of the display area and n0 as the number of the sub-pixels in a full size display area in the horizontal direction on each side of the display area, n0−n1=3, n1−n2=3, n3−n2=3, etc. are satisfied, also in the same manner as in FIG. 3.

However, in the pixel shape in FIG. 10, the aspect ratio of the sub-pixel 11 is different from that in FIG. 4 and the shape of the pixel 10 is not a square shape but a horizontally oblong rectangular shape. Accordingly, the angle of inclination θ in the display area represented by tan⁻¹(yp/xp) is smaller than that in the first embodiment. That is, if it is intended to set the angle of inclination θ in the display area to an optional angle, the invention is applicable to an optional angle of inclination θ in the display area by changing the shape of the sub-pixel 11, that is, the pixel 10.

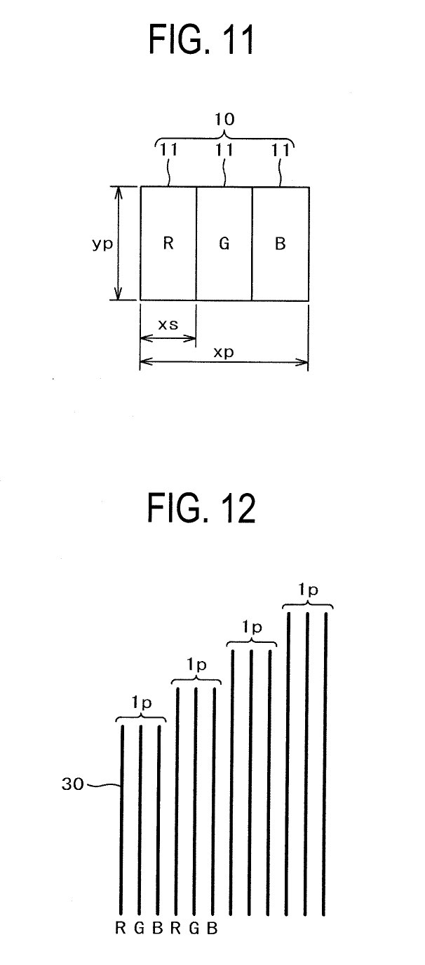

FIG. 12 is a view in which only the video signal lines 30 are extracted from FIG. 11. In FIG. 12, 1 p shows video signal line 30 for one pixel. That is, the magnitude of the video signal in the source driver 80 is controlled easily by uniformly changing the length of the video signal line 30 on the unit of three lines for every scanning line in the same manner as in the first embodiment, etc.

FIG. 10 shows a case where the angle of inclination θ in the display area is made smaller than 45 degree, but the invention is applicable also to a case in which the θ is made larger than 45 degree. That is, the pixel 10 is may be a vertically oblong rectangular shape in this case instead of the square shape. The invention is applicable also to the optional angle of inclination θ in the display area by changing the shape of the pixel 10 in accordance with the display area sloping portion 61.

### Fourth Embodiment

The pixel 10 comprises three sub-pixels 11 in the first embodiment to the third embodiment. However, the number of the sub-pixels 11 is not restricted to three.

Although not illustrated, the technique of the invention as explained in the first embodiment to the third embodiment is applicable also to a display device in which the pixel comprises a plurality of sub-pixels, and the same effect as those in the first embodiment to the third embodiment can be obtained. For example, the pixel may comprise four sub-pixels. The four sub-pixels comprise, for example, a red sub-pixel, a green sub-pixel, a blue sub-pixel, and a white sub-pixel. The invention is applicable also to a case where the colors of the plurality of sub-pixels are other than those of the examples described above.

Description has been made to the liquid crystal display device. However, the invention is applicable not only to the liquid crystal display device but also to display devices where pixels 10 or sub-pixels 11 are formed in a matrix in the display area 60. For example, in an organic EL display device, sub-pixels 11 each having a light emitting device and a control TFT are formed on a device substrate, and such sub-pixels 11 are formed in a matrix. Further, the pixel 10 is formed with three sub-pixels 11 each emitting a light of red, green, and blue. Then, the device substrate is sealed, for example, with a glass plate. The invention as described above is applicable also to the display area of such an organic EL display device.

Further, the invention is not restricted to a hexagonal shape in which two corners are cut-off as shown in FIG. 1 but the invention is applicable also to a display device having a display area of a shape formed by cutting-off four corners from a rectangular shape, for example, a shape formed by cutting-off four corners.

What is claimed is:

1. A display device comprising:
scanning lines extended in a first direction and arranged in a second direction;
video signal lines extended in the second direction and arranged in the first direction; and
sub-pixels formed in each of regions surrounded by the scanning lines and the video signal lines, a set of the sub-pixels by the number of n defining a pixel;
wherein a display area has a hexagonal shape containing a display area sloping portion of a shape formed by cutting-off a corner from a rectangular shape, and
the number of the sub-pixels in an extending direction of the scanning lines in the display area sloping portion changes uniformly for every sub-pixels by the number of n or for every sub-pixels by the number of a multiple of n on each side of the display area for every one scanning line.

2. A display device according to claim 1, wherein n is 3.

3. A display device according to claim 1, wherein the number of the sub-pixels in the extending direction of the scanning lines in the display area sloping portions changes uniformly for every sub-pixels by the number of n on each side of the display area for every one scanning line.

4. A display device comprising:
scanning lines extended in a first direction and arranged in a second direction;
video signal lines extended in the second direction and arranged in the first direction; and
sub-pixels formed in each of regions surrounded by the scanning lines and the video signal lines, a set of the sub-pixels by the number of n defining a pixel;
wherein a display area has a hexagonal shape containing a display area sloping portion of a shape formed by cutting-off a corner from a rectangular shape,
an angle of the display area sloping portion relative to the scanning line is represented by tan⁻¹(yp/xp) assuming a horizontal diameter of a pixel as px and a vertical diameter of the pixel as py, and
the number of the sub-pixels in an extending direction of the scanning lines in the display area sloping portion changes uniformly for every sub-pixels by the number of n or for every sub-pixels by the number of a multiple of n on each side of the display area for every one scanning line.

5. A display device according to claim 4, wherein n is 3.

6. A display device according to claim 4, wherein the number of sub-pixels in the extending direction of the scanning line in the display area sloping portion changes uniformly for every sub-pixels by the number of n on each side of a display area for every one scanning line.

7. A display device according to claim 1, wherein the display device is a liquid crystal display device.

8. A display device according to claim 1, wherein the display device is an organic El display device.
